(19) United States
(12) Patent Application Publication
(10) Pub. No.: US 2024/0388149 A1
(43) Pub. Date: Nov. 21, 2024

(54) ROTOR AND MOTOR

(71) Applicants: Nidec Motion Control Technology (Guangdong) Co., LTD, Foshan City (CN); NIDEC CORPORATION, Kyoto (JP)

(72) Inventors: Sheng-Chan YEN, Taipei city (TW); Ta-Yin LUO, Taipei city (TW); Tian-Bao WANG, Foshan City (CN); Zhi-Min ZHOU, Foshan City (CN); Zeng-Xiang GU, Foshan City (CN); Ruo-Hui WU, Foshan City (CN); Sheng-Wang WEI, Foshan City (CN)

(21) Appl. No.: 18/668,096

(22) Filed: May 17, 2024

(30) Foreign Application Priority Data
May 19, 2023 (CN) 202310573808.8

(51) Int. Cl. H02K 1/276

(52) U.S. Cl. CPC H02K 1/2766; H02K 2213/03

(57) ABSTRACT

Embodiments of the present application provide a rotor and a motor. The rotor has a plurality of through-hole groups. Each through-hole group has a plurality of through-holes distributed in a radial direction. The rotor also has auxiliary holes. Each auxiliary hole is located between every two radially adjacent through-holes. A sectional area of each auxiliary hole is less than a sectional area of each through-hole. When a first angle, a second angle and a third angle are defined between three portions of each auxiliary hole and the q-axis respectively, the third angle is greater than or equal to the first angle, and the third angle is less than or equal to the second angle.

### CROSS-REFERENCE TO RELATED APPLICATIONS

The present invention claims priority under 35 U.S.C. § 119 to Chinese Patent Application No. 202310573808.8 filed on May 19, 2023, the entire content of which is incorporated herein by reference.

### FIELD OF THE INVENTION

Embodiments of the present application relate to the field of motors.

### BACKGROUND

In a rotor of a traditional synchronous reluctance motor (SynRM), an electromagnetic steel plate that constitutes the rotor has a plurality of through-holes in the middle. These through-holes form air gaps called magnetic flux barriers. These air gaps cause differences in reluctance. When a stator of the motor is energized with a current, a reluctance torque is generated due to the reluctance difference, thereby driving the rotor to rotate.

In order to further improve the efficiency of the motor and increase a power coefficient of the motor, magnets may be inserted into the magnetic flux barriers to form a permanent magnet-assisted synchronous reluctance motor (PMa-SynRM), in which the magnets inserted into the magnetic flux barriers can generate additional magnetic flux and contribute a magnetic flux torque, so that the output of the motor includes the combination of the reluctance torque and the magnetic flux torque, thus achieving higher efficiency.

It should be noted that the above introduction to the technical background is only for the convenience of a clear and complete description of the technical solutions of the present application, and for the convenience of understanding by those skilled in the art. It cannot be considered that the above technical solutions are known to those skilled in the art just because these solutions are described in the background section of the present application.

### SUMMARY

A magnetic flux barrier of a permanent magnet-assisted synchronous reluctance motor needs to match a stator slot to produce a greater torque and smaller torque ripple. Magnets need to be of a certain thickness because the magnets themselves have manufacturing limitations, for example, If the magnet is too thin, it is difficult to mount and easy to break. Considering that a radial dimension of a rotor left after a rotating shaft is removed is limited, there is often a mismatch between the number of magnetic flux barriers and the number of stator slots, i.e., there is a slotting effect. In this case, it is difficult to effectively reduce torque ripples of the rotor.

According to a first aspect of embodiments of the present application, a rotor is provided. The rotor is capable of rotating around a central axis, and has a plurality of through-hole groups that penetrates through the rotor in an axial direction, each through-hole group having a plurality of through-holes distributed in a radial direction, and on a section of the rotor perpendicular to the central axis, a straight line passing through a circumferential center of each through-hole and the central axis being a q-axis; the rotor further has auxiliary holes; each auxiliary hole is located between every two radially adjacent through-holes; a sectional area of each auxiliary hole is less than a sectional area of each through-hole; a length of each auxiliary hole in one direction is greater than a width of the auxiliary hole in another direction perpendicular to the one direction; an included angle between a center line at an end of the through-hole adjacent to a radially inner side of the auxiliary hole and the q-axis is a first angle (a2); an included angle between a center line at an end of the through-hole adjacent to a radially outer side of the auxiliary hole and the q-axis is a second angle (a3), and an included angle between a center line at an end of each auxiliary hole and the q-axis is a third angle (La23), wherein the third angle is greater than or equal to the first angle, and the third angle is less than or equal to the second angle.

According to a second aspect of the embodiments of the present application, a motor is provided, in which the motor includes the rotor described in the first aspect of the embodiments.

One of the beneficial effects of the embodiments of the present application is that an auxiliary hole is provided in the rotor. The cross-sectional area of the auxiliary hole is smaller than the cross-sectional area of the magnetic flux barrier. Therefore, the magnetic flux in the rotor can be adjusted, thereby effectively reducing the torque ripple of the rotor. In addition, setting the center line of the end of the auxiliary hole to an appropriate angle can reduce the influence of the auxiliary hole on the distribution of magnetic flux paths in the rotor.

With reference to the following description and accompanying drawings, specific implementations of the present application are disclosed in detail to indicate a manner in which the principles of the present application may be employed. It should be understood that the implementations of the present application are not limited thereby in scope. Implementations of the present application encompass many changes, modifications and equivalents within the scope of the spirit and terms of the appended claims.

The above and other elements, features, steps, characteristics and advantages of the present disclosure will become more apparent from the following detailed description of the preferred embodiments with reference to the attached drawings.

### BRIEF DESCRIPTION OF THE DRAWINGS

The included accompanying drawings are used to provide a further understanding of the embodiments of the present application, which constitute a part of the description to illustrate the implementations of the present application, and explain the principle of the present application together with the text description. Apparently, the accompanying drawings in the following description are only some embodiments of the present application, and those of ordinary skilled in the art can also obtain other accompanying drawings according to these drawings without paying creative work. In the accompanying drawings:

FIG. 1 is a top view of a rotor according to an embodiment in a first aspect of the present application;

FIG. 2 is an enlarged schematic diagram of a dot-dash line area 1a in FIG. 1;

FIG. 3 is another top view of the rotor according to the embodiment in the first aspect of the present application;

FIG. 4 is yet another top view of the rotor according to the embodiment in the first aspect of the present application;

FIG. 5 is still another top view of the rotor according to the embodiment in the first aspect of the present application;

FIGS. 6A and 6B are still another top views of the rotor according to the embodiment in the first aspect of the present application;

FIG. 7 is still another top view of the rotor according to the embodiment in the first aspect of the present application;

FIG. 8 is another top view of the rotor according to the embodiment in the first aspect of the present application; and

FIG. 9 is an exploded schematic view of a motor according to an embodiment in a second aspect of the present application.

### DETAILED DESCRIPTION

The foregoing and other features of the present application will become apparent from the following description with reference to the accompanying drawings. In the description and accompanying drawings, specific implementations of the present application are disclosed in detail, which indicate some implementations in which the principles of the present application can be adopted. It should be understood that the present application is not limited to the described implementations. On the contrary, the present application includes all modifications, variations and equivalents that fall within the scope of the appended claims.

In the embodiments of the present application, the terms “first”, “second”, etc. are used to distinguish different elements from the names, but do not indicate a spatial arrangement or chronological order of these elements, etc., and these elements should not be limited by these terms. The term “and/or” includes any one and all combinations of one or more of the associated listed terms. The terms “comprising”, “including”, “having” and the like refer to the presence of stated features, elements, component or assemblies, but do not exclude the presence or addition of one or more other features, elements, components or assemblies.

In the embodiments of the present application, the singular forms “a”, “this” and the like include plural forms, which should be broadly understood as “a kind” or “a class” and not limited to the meaning of “one”. In addition, the term “the” should be understood to include both the singular form and the plural form, unless the context clearly dictates otherwise. Furthermore, the term “according to” should be understood as “at least in part according to . . . ”; and the term “based on” should be understood as “at least in part based on . . . ”, unless the context clearly indicates otherwise.

In the following description of the present application, for the convenience of explanation, a direction that extends along a central axis of a rotor or a direction parallel to this central axis is called an “axial direction”, a radius direction with the central axis as a center is called a “radial direction”, and a direction around the central axis is called a “circumferential direction”, but these are only for convenience of explanation and do not limit an orientation of the rotor during use and manufacture.

An embodiment in the first aspect of the present application provides a rotor.

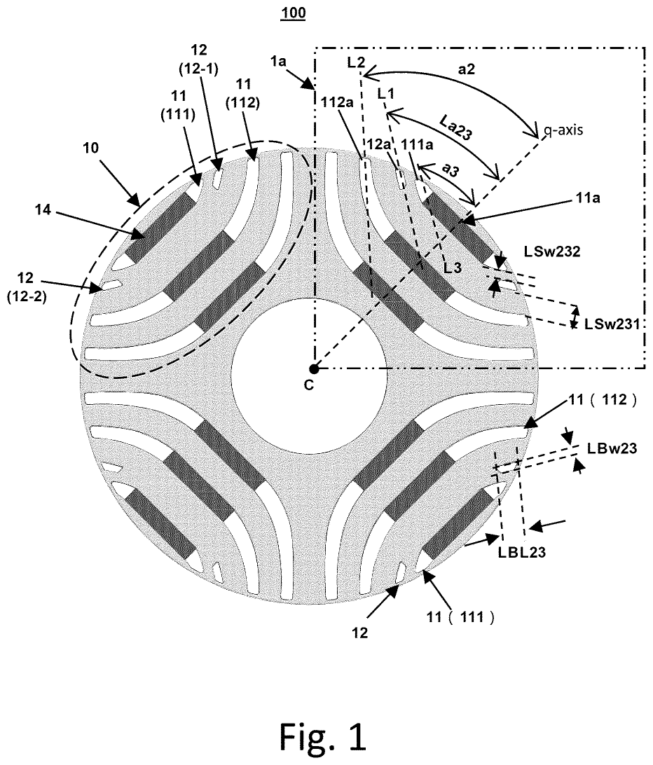

FIG. 1 is a top view of a rotor according to an embodiment in a first aspect of the present application. Since the rotor is composed of a plurality of steel plates stacked in an axial direction, FIG. 1 shows an end surface of one steel plate in the axial direction. The steel plates used to form the rotor are, for example, silicon steel plates.

As shown in FIG. 1, a rotor 100 is capable of rotating about a central axis C. The rotor 100 has a plurality of through-hole groups 10 that penetrates through the rotor 100 in an axial direction (there are four through-hole groups 10 in FIG. 1, and one of the through-hole groups 10 is circled with a dotted circle), and each through-hole group 10 includes a plurality of through-holes 11 that is distributed in a radial direction. The through-holes 11 may be called magnetic flux barriers. A distribution pattern of the plurality of through-hole groups 10 on the rotor 100 and the shape of each through-hole 11 may refer to related technologies.

It should be noted that, in some embodiments, both ends of at least one through-hole 11 in the axial direction may be open. In other embodiments, one end or both ends of at least one through-hole 11 in the axial direction may be closed by plate components mounted on an axial end surface of the rotor 100, or one end or both ends of at least one through-hole 11 in the axial direction may be closed by an insertion component inserted into this through-hole 11. In which, the plate component or the insertion component may be made of a non-magnetic material such as aluminum or plastic. In addition, the plate component or the insertion component may be made of steel or other materials.

In a section of the rotor 100 perpendicular to a central axis C, a straight line passing through a circumferential center 11a of each through-hole 11 and the central axis C is a q-axis. Each through-hole group 10 has its own q-axis.

As shown in FIG. 1, the rotor 100 also has at least one auxiliary hole 12. The auxiliary hole 12 is located between radially adjacent through-holes 11. For example, the auxiliary hole 12 is located between the first through-hole 111 and the second through-hole 112 in the radial direction. The first through-hole 111 and the second through-hole 112 are two through-holes radially adjacent to each other.

A sectional area of the auxiliary hole 12 is less than a sectional area of the through-hole 11. For example, the first through-hole 111 is a through-hole having the smallest sectional area in each through-hole group 10, and a sectional area of the auxiliary hole 12 is less than a sectional area of the first through-hole 111. Here, the sectional area refers to an area of a projection of the auxiliary hole 12 or the through-hole 11 on a plane perpendicular to the axial direction.

As shown in FIG. 1, on a plane perpendicular to the axial direction, a length LBL23 of the auxiliary hole 12 in one direction is greater than a width LBw23 of the auxiliary hole 12 in another direction, in which the other direction is perpendicular to the one direction. The one direction may be a length direction of the auxiliary hole 12, and the other direction may be a width direction of the auxiliary hole 12. For example, the auxiliary hole 12 has an elongated shape, an elliptical shape, or the like. In addition, for the auxiliary holes 12 at different positions, the length directions may be different from each other; and for the auxiliary holes 12 at different positions, the width directions may be different from each other.

In some embodiments of the present application, both ends of at least one auxiliary hole 12 in the axial direction may be open. In other embodiments, one end or both ends of at least one auxiliary hole 12 in the axial direction may be closed by plate components mounted on an axial end surface of the rotor 100, or one end or both ends of at least one auxiliary hole 12 in the axial direction may be closed by an insertion component inserted into this auxiliary hole 12. In which, the plate component or the insertion component may be made of a non-magnetic material such as aluminum or plastic. In addition, the plate component or the insertion component may be made of steel or other materials.

As shown in FIG. 1:
an included angle between a center line L2 at an end 112a of the through-hole 11 (e.g., the second through-hole 112) adjacent to a radially inner side of the auxiliary hole 12 and the q-axis is a first angle a2;
an included angle between a center line L3 at an end 111a of the through-hole 11 (e.g., the first through-hole 111) adjacent to a radially outer side of the auxiliary hole 12 and the q-axis is a second angle a3; and
an included angle between a center line L1 at an end 12a of the auxiliary hole 12 and the q-axis is a third angle La23,
in which, the third angle La23 is greater than or equal to the first angle a2, and the third angle La23 is less than or equal to the second angle a3, that is, a2≤La23≤a3.

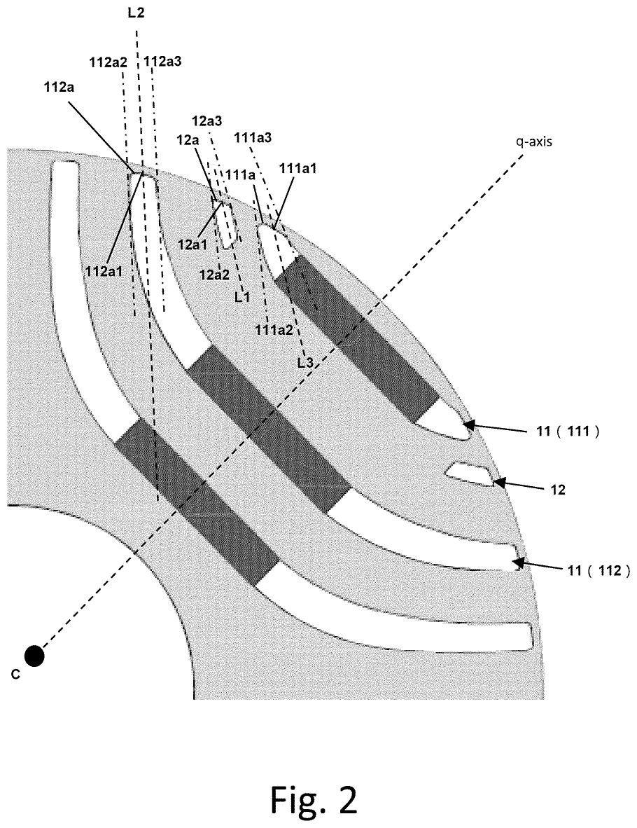

FIG. 2 is an enlarged schematic diagram of a dot-dash line area la in FIG. 1, used to illustrate the definitions of center lines L1, L2, and L3.

As shown in FIG. 2, a midpoint at the end 112a of the through-hole 11 (e.g., the second through-hole 112) adjacent to the radially inner side of the auxiliary hole 12 is 112a1, tangent lines on both sides of the end 112a are 112a2 and 112a3 respectively, and the center line L2 passes through the midpoint 112a1. In which, an included angle between the center line L2 and the tangent line 112a2 and an included angle between the center line L2 and the tangent line 112a3 are equal in magnitude but opposite in direction; or, the tangent lines 112a2, 112a3 and the center line L2 are all parallel.

As shown in FIG. 2, a midpoint at the end 111a of the through-hole 11 (e.g., the first through-hole 111) adjacent to the radially outer side of the auxiliary hole 12 is 111a1, tangent lines on both sides of the end 111a are 111a2 and 111a3 respectively, and the center line L3 passes through the midpoint 111a1. In which, an included angle between the center line L3 and the tangent line 111a2 and an included angle between the center line L3 and the tangent line 111a3 are equal in magnitude but opposite in direction; or, the tangent lines 111a2, 111a3 and the center line L3 are all parallel.

As shown in FIG. 2, a midpoint at the end 12a of the auxiliary hole 12 is 12a1, tangent lines on both sides of the end 12a are 12a2 and 12a3 respectively, and the center line L1 passes through the midpoint 12a1. In which, an included angle between the center line L1 and the tanget line 12a2 and an included angle between the center line L1 and the tangent line 12a3 are equal in magnitude but opposite in direction; or, the tangent lines 12a2, 12a3 and the center line L1 are all parallel.

According to the embodiment in the first aspect, an auxiliary hole 12 is provided in the rotor 100, and a sectional area of the auxiliary hole 12 is less than a sectional area of the through-hole 11, such that a magnetic flux in the rotor 100 can be adjusted by the auxiliary hole 12, thereby effectively reducing torque ripples of the rotor 100. In addition, by setting the center line at the end of the auxiliary hole 12 to an appropriate angle, the length direction of the auxiliary hole 12 is as far as possible along a direction of a magnetic flux path between the radially adjacent through-holes (e.g., the first through-hole 111 and the second through-hole 112), so as to reduce the influence of the auxiliary hole 12 on the distribution of magnetic flux paths in the rotor 100.

In at least one embodiment, as shown in FIG. 1: a spacing width between the auxiliary hole 12 and the through-hole 11 (e.g., the second through-hole 112) adjacent to the radially inner side of the auxiliary hole 12 is a first width LSw231; and a spacing width between the auxiliary hole 12 and the through-hole 11 (e.g., the first through-hole 111) adjacent to the radially outer side of the auxiliary hole 12 is a second width LSw232, in which the first width is greater than or equal to 2 times of the second width, and the first width is less than or equal to 3 times of the second width, that is, 2*LSw232≤LSw231 ≤3*LSw232. The magnetic flux density on a side of the magnetic flux path close to the stator is usually higher than the magnetic flux density on a side away from the stator. Therefore, through the above limitation of a quantitative relationship between the first widths and the second widths, the impact of the slotting effect can be reduced, the distribution of the magnetic flux density is made uniform, thereby further reducing torque ripples.

In at least one embodiment, the width LBw23 of the auxiliary hole 12 is greater than or equal to 0.9 times of the second width LSw232, and the width LBw23 of the auxiliary hole 12 is less than or equal to 1.1 times of the second width LSw232, that is, 0.9*LSw232≤LBw23≤1.1*LSw232.

In at least one embodiment, the length LBL23 of the auxiliary hole 12 is less than or equal to 3 times of the width LBw23 of the auxiliary hole 12, that is, LBw23<LBL23≤3*LBw23.

In at least one embodiment, as shown in FIG. 1, the auxiliary holes 12 may be arranged in pairs. For example, the auxiliary holes 12-1 and 12-2 may be arranged symmetrically with respect to the q-axis. That is, the auxiliary hole 12-1 and the auxiliary hole 12-2 may be symmetrical in position with respect to the q-axis. In addition, the shapes of the auxiliary hole 12-1 and the auxiliary hole 12-2 may be symmetrical with respect to the q-axis.

In addition, the embodiments of the present application may not be limited thereto. For example, the positions of the auxiliary hole 12-1 and the auxiliary hole 12-2 may not be set symmetrically with respect to the q-axis, and/or the shapes of the auxiliary hole 12-1 and the auxiliary hole 12-2 may not be set symmetrically with respect to the q-axis. In addition, the auxiliary holes 12 may not be provided in pairs. For example, for at least one through-hole group 10, the auxiliary holes 12 may be provided on one side of the q-axis between the radially adjacent through-holes 11.

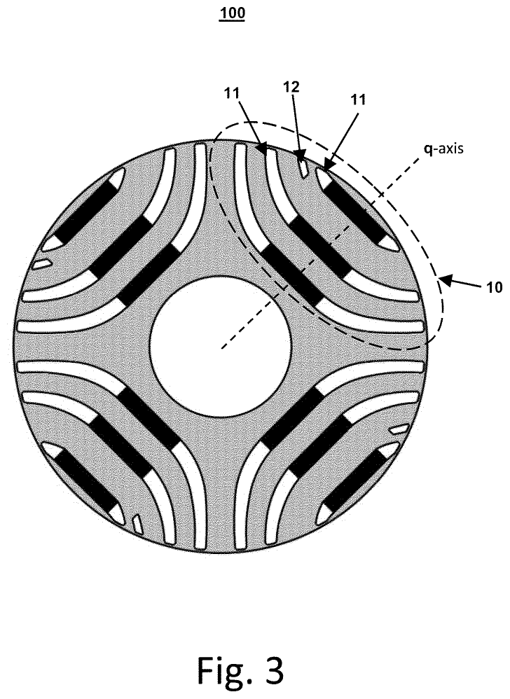

FIG. 3 is another top view of the rotor according to the embodiment in the first aspect of the present application. FIG. 3 differs from FIG. 1 in that: in FIG. 3, for at least one through-hole group 10, the auxiliary holes 12 may be provided on one side of the q-axis between the radially adjacent through-holes 11, so the auxiliary holes 12 in FIG. 3 are not provided symmetrically with respect to the q-axis.

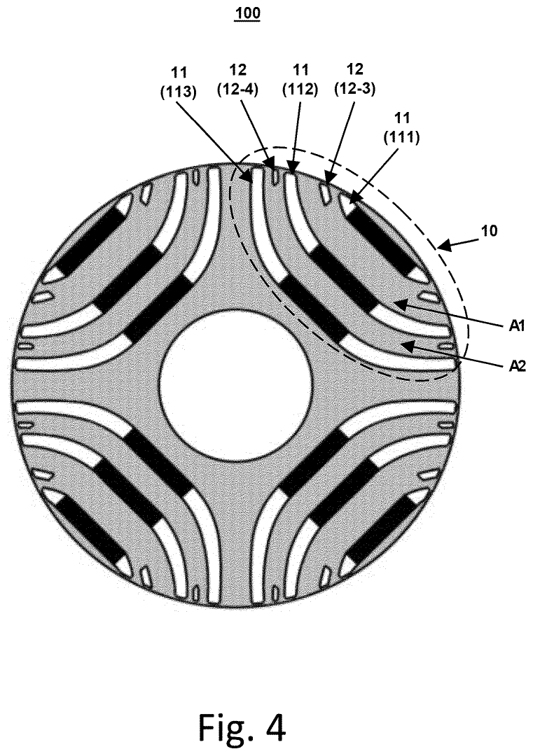

FIG. 4 is yet another top view of the rotor according to the embodiment in the first aspect of the present application. FIG. 4 differs from FIG. 1 in that: in FIG. 4, at least two auxiliary holes 12 are provided in different areas in a radial direction.

As shown in FIG. 4, the number of the plurality of through-holes 11 in the through-hole group 10 of the rotor 100 is 3. Among the plurality of through-holes 11, an area between the radially adjacent first through-hole 111 and second through-hole 112 in the radial direction is a first area A1. In which, the first through-hole 111 is located on the radially outer side of the second through-hole 112, and among the plurality of through-holes 11 of the through-hole group 10, the first through-hole 111 is located on a radially outermost side.

As shown in FIG. 4, in this through-hole group 10, an area between the second through-hole 112 and the third through-hole 113 in the radial direction is a second area A2. In which, the second through-hole 112 is located on a radially outer side of the third through-hole 113.

As shown in FIG. 4, among the at least two auxiliary holes 12, at least one auxiliary hole 12 (e.g., labeled as an auxiliary hole 12-3 in FIG. 4) is located in the first area A1, and at least another auxiliary hole 12 (e.g., labeled as an auxiliary hole 12-4 in FIG. 4) is located in the second area A2. Therefore, the magnetic flux density at different radial positions can be adjusted by using the auxiliary holes 12.

In addition, when the number of through-holes 112 is 4 or more, the second area A2 may be located between the second through-hole 112 and the third through-hole 113 in the radial direction, or the second area A2 may be located between the third through-hole 113 and the fourth through-hole (not shown) in the radial direction. In which, the third through-hole 113 is radially adjacent to the fourth through-hole, and the third through-hole 113 may be located on a radially outer side of the fourth through-hole.

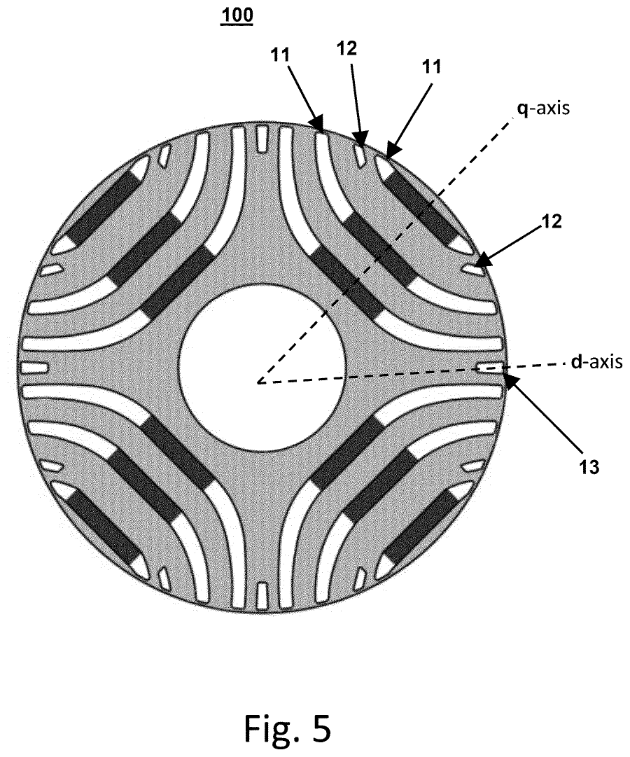

FIG. 5 is still another top view of the rotor according to the embodiment in the first aspect of the present application. FIG. 5 differs from FIG. 1 in that: in FIG. 5, in addition to the auxiliary hole 12, the rotor 100 also has a first auxiliary hole 13. The first auxiliary hole 13 is located on a d-axis. That is, on a section of the rotor 100 perpendicular to the central axis C, the d-axis passes through the first auxiliary hole 13. The first auxiliary hole 13 can also reduce the torque ripples.

On the section of the rotor 100 perpendicular to the central axis C, the d-axis intersects the q-axis. For example, an included angle between the d-axis and the q-axis is 45 degrees, 30 degrees or the like.

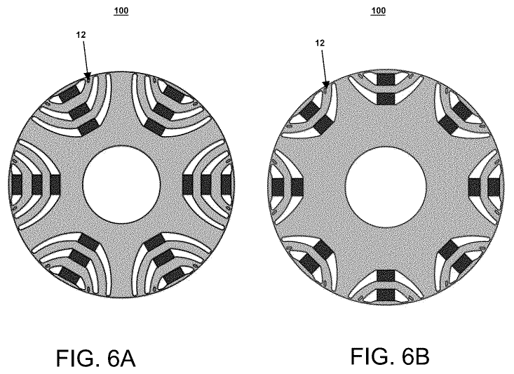

FIGS. 6A and 6B are still another top views of the rotor according to the embodiment in the first aspect of the present application. FIG. 6A shows a 6-pole rotor, and FIG. 6B shows an 8-pole rotor. The similarities between FIGS. 6A and 6B and FIG. 1 will not be described again. In the present application, the design related to the auxiliary hole 12 can be used not only for a 4-pole rotor shown in FIG. 1, but also for the 6-pole rotor and 8-pole rotor shown in FIGS. 6A and 6B. The number of poles of the rotor will not be limited in the present application.

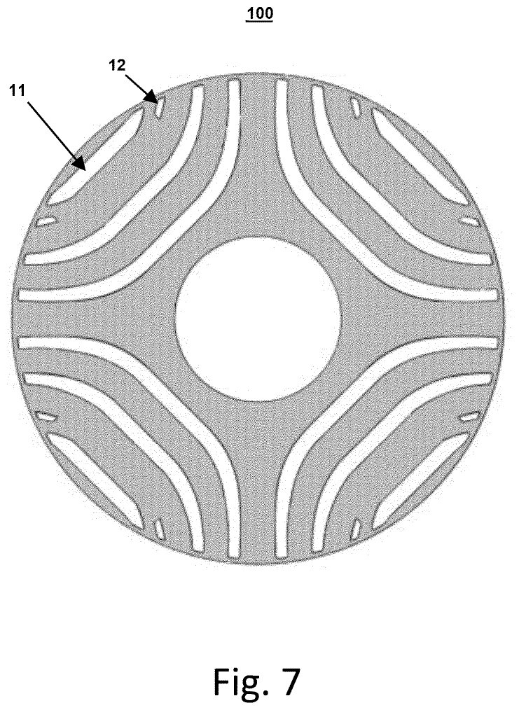

FIG. 7 is still another top view of the rotor according to the embodiment in the first aspect of the present application. FIG. 7 differs from FIG. 1 in that: in FIG. 1, a magnet 14 is provided in the at least one through-hole 11 of the rotor 100, so the magnet 14 may be used to form a permanent magnet-assisted synchronous reluctance motor. In FIG. 7, no magnet may be provided in the through-hole 11 of the rotor 100. In the present application, the design related to the auxiliary hole 12 may be used not only for the rotor with the magnet in the through-hole shown in FIG. 1, but also for the rotor without a magnet in the through-hole shown in FIG. 7. Whether a magnet is provided in the through-hole will not be limited in the present application.

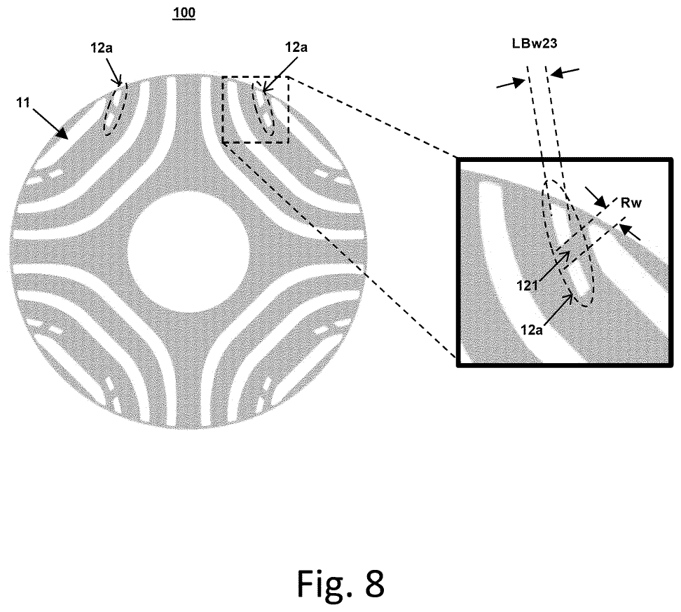

In at least one embodiment, FIG. 8 is another top view of the rotor according to the embodiment in the first aspect of the present application. The descriptions of the rotor 100 in FIGS. 1 to 7 are applicable to the rotor 100 shown in FIG. 8.

In the present application, the auxiliary hole 12a of the rotor 100 in FIG. 8 differs from the auxiliary hole 12 of the rotor 100 in FIGS. 1 to 7 in that: at least one partition wall 121 is provided in the auxiliary hole 12a. The partition wall 121 divides the auxiliary hole 12a into at least two portions (e.g., at least 2 sub-holes) which are distributed in a length direction of the auxiliary hole 12a and are not communicated with each other.

As shown in FIG. 8, along the length direction of the auxiliary hole 12a, a size Rw of the partition wall 121 is greater than or equal to the width LBw23 of the auxiliary hole 12a, and is less than or equal to 1.5 times of the width LBw23 of the auxiliary hole 12a, that is, 1.0*LBw23≤Rw≤1.5*LBw23.

In some scenarios, a magnetic saturation of the rotor is relatively low. The partition wall 121 of the auxiliary hole 12a shown in FIG. 8 can become a channel for magnetic flux, thereby adjusting the distribution of magnetic flux density and suppressing the torque pulsation. For example, in a high-speed and low-torque scenario, the partition wall 121 can have a damping effect on the torque pulsation of the rotor.

Table 1 shows the performance improvement of the motor when using the rotor according to the embodiment in the first aspect of the present application.

TABLE 1

| | | | Rotor according to |
|---|---|---|---|
| | | | the embodiment in |
| | | | the first aspect of |
| | | Traditional | the present |
| Performance parameters | | rotor | application |
| 25.5 Nm @ | Current | 235 A | 233 A |
| 1444 rpm | Efficiency | 81.93% | 82.13% |
| | Torque ripple | 11.91% | 7.89% |
| 19.5 Nm @ | Current | 185 A | 185 A |
| 1660 rpm | Efficiency | 85.82% | 85.95% |
| | Torque ripple | 13.50% | 9.53% |
| 12.2 Nm @ | Current | 174.5 A | 170.0 A |
| 2570 rpm | Efficiency | 85.96% | 86.55% |
| | Torque ripple | 23.65% | 14.87% |

Table 1 lists different performances of the motor using the traditional rotor and the rotor 100 according to the embodiment in the first aspect of the present application at different operating points.

For example:

at the operating point with a torque of 25.5 Nm and a rotational speed of 1444 rpm, the torque ripple is reduced from 11.9% to 7.89%;

at the operating point with a torque of 19.5 Nm and a rotational speed of 1660 rpm, the torque ripple is reduced from 13.50% to 9.53%; and at the operating point with a torque of 12.2 Nm and a rotational speed of 2570 rpm, the torque ripple is reduced from 23.65% to 14.87%.

It can be seen that in the case of adopting the rotor 100 according to the embodiment in the first aspect of the present application, the torque ripple of the motor has been significantly reduced. In addition, the efficiency of the motor has also been improved to a certain extent.

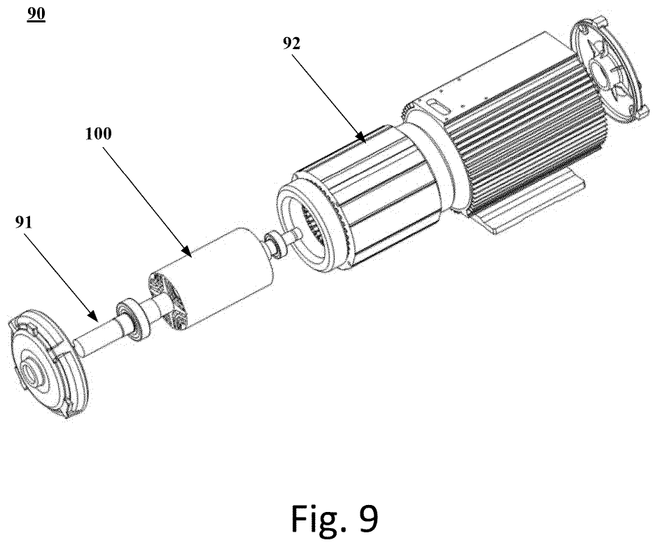

An embodiment in the second aspect of the present application provides a motor. FIG. 9 is an exploded schematic diagram of the motor according to the embodiment in the second aspect of the present application.

As shown in FIG. 9, the motor 90 may include: a rotating shaft 91, which extends along a central axis; a stator 92, which is provided with circumferentially arranged polar grooves (i.e., a stator groove); teeth formed between adjacent polar grooves (not shown); coils accommodated in the polar grooves (not shown); and a rotor 100, which rotates around the rotating shaft 91. Since the structure of the rotor 100 has been described in detail in the embodiment in the first aspect of the present application, its contents are contained herein and will not be repeated here.

In one or more embodiments, the motor 90 may be a one-way rotating motor or a two-way rotating motor.

In one or more embodiments, the other constituent parts of the motor 90 are the same as the prior art, and will not be repeated herein.

An embodiment in the third aspect of the present application provides a driving apparatus. The driving apparatus includes a motor as described in the embodiment in the second aspect of the present application. Since the main structure of the motor has been described in detail in the embodiment in the second aspect of the present application, its contents are contained herein and will not be repeated here.

In one or more embodiments, the driving apparatus may be any device for mounting a motor. The motor may be applied to the power transmission of industrial motors, compression pumps, household devices, etc.

The present application is described above in conjunction with specific embodiments, but those skilled in the art should be clear that these descriptions are exemplary and are not intended to limit the protection scope of the present application. Those skilled in the art can make various variations and modifications to the present application according to the spirit and principles of the present application, and these variations and modifications are also within the scope of the present application.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotor, rotatable around a central axis, having a plurality of through-hole groups that penetrates through the rotor in an axial direction, each through-hole group having a plurality of through-holes distributed in a radial direction, and on a section of the rotor perpendicular to the central axis, a straight line passing through a circumferential center of each through-hole and the central axis being a q-axis; wherein
the rotor further has auxiliary holes;
each auxiliary hole is located between every two radially adjacent through-holes;
a sectional area of each auxiliary hole is less than a sectional area of each through-hole;
a length of each auxiliary hole in one direction is greater than a width of the auxiliary hole in another direction perpendicular to the one direction;
an included angle between a center line at an end of the through-hole adjacent to a radially inner side of the auxiliary hole and the q-axis is a first angle;
an included angle between a center line at an end of the through-hole adjacent to a radially outer side of the auxiliary hole and the q-axis is a second angle;
an included angle between a center line at an end of each auxiliary hole and the q-axis is a third angle; and
the third angle is greater than or equal to the first angle, and the third angle is less than or equal to the second angle.

2. The rotor of claim 1, wherein
a spacing width between each auxiliary hole and the through-hole adjacent to the radially inner side of the auxiliary hole is a first width;
a spacing width between each auxiliary hole and the through-hole adjacent to the radially outer side of the auxiliary hole is a second width; and
the first width is greater than or equal to 2 times of the second width, and the first width is less than or equal to 3 times of the second width.

3. The rotor of claim 2, wherein the width of each auxiliary hole is greater than or equal to 0.9 times of the second width, and the width of the auxiliary hole is less than or equal to 1.1 times of the second width.

4. The rotor of claim 1, wherein the length of each auxiliary hole is less than or equal to 3 times of the width of the auxiliary hole.

5. The rotor of claim 1, wherein each auxiliary hole has at least one partition wall, and the partition wall divides the auxiliary hole into at least two sub-holes which are distributed in a length direction of the auxiliary hole and not communicated with each other.

6. The rotor of claim 5, wherein along the length direction of each auxiliary hole, the partition wall has a size greater than or equal to the width of the auxiliary hole, and less than or equal to 1.5 times of the width of the auxiliary hole.

7. The rotor of claim 1, wherein
the number of the plurality of through-holes is 3 or 4 or more;
an area between the radially adjacent first through-hole and second through-hole among the plurality of through-holes in a radial direction is a first area, the first through-hole is located on a radially outer side of the second through-hole, and among the plurality of through-holes, the first through-hole is located on the radially outermost side;
an area between the radially adjacent third through-hole and fourth through-hole among the plurality of through-holes in a radial direction is a second area, or an area between the second through-hole and the third through-hole in the radial direction is a second area;
when the number of the through-holes is 3, the second through-hole is located on a radially outer side of the third through-hole;
when the number of the through-holes is 4 or more, the third through-hole is located on a radially outer side of the fourth through-hole; and
the number of the auxiliary holes is at least 2, wherein at least one of the auxiliary holes is located in the first area, and at least another of the auxiliary holes is located in the second area.

8. The rotor of claim 1, wherein
the rotor also has a first auxiliary hole; and
in the section of the rotor perpendicular to the central axis, the first auxiliary hole is located on a d-axis.

9. The rotor of claim 1, wherein the rotor further comprises a magnet, and the magnet is provided in at least one of the through-holes.

10. A motor comprising a rotor of claim 1.

11. A motor comprising a rotor of claim 5.

12. A motor comprising a rotor of claim 7.
